(19) United States
(12) Patent Application Publication
(10) Pub. No.: US 2011/0311048 A1
(43) Pub. Date: Dec. 22, 2011

(54) CRYPTOGRAPHIC OPERATION APPARATUS, STORAGE APPARATUS, AND CRYPTOGRAPHIC OPERATION METHOD

(75) Inventors: Yuki NAGATA, Kanagawa (JP); Koichi Fujisaki, Kanagawa (JP)

(73) Assignee: Kabushiki Kaisha Toshiba, Tokyo (JP)

(21) Appl. No.: 13/158,597

(22) Filed: Jun. 13, 2011

(30) Foreign Application Priority Data
Jun. 22, 2010 (JP) 2010-141473

(51) Int. Cl. H04K 1/02

(52) U.S. Cl. 380/252

(57) ABSTRACT

According to one embodiment, the cryptographic operation apparatus performs a cryptographic operation using first and second key data and includes an initial mask value creating unit that creates the initial mask value using the second key data and data information. In addition, the cryptographic operation apparatus further includes a mask value updating unit that creates the mask value using the initial mask value and a mask value storing unit that stores and outputs the initial mask value and the created mask value. In addition, the encryption is performed using the input data, the first key data, and the output mask value.

### CROSS-REFERENCE TO RELATED APPLICATIONS

This application is based upon and claims the benefit of priority from the prior Japanese Patent Application No. 2010-141473, filed on Jun. 22, 2010; the entire contents of which are incorporated herein by reference.

### FIELD

Embodiments described herein relate generally to a cryptographic operation apparatus, a storage apparatus, and a cryptographic operation method.

### BACKGROUND

Since a block cipher algorithm is designed to conceal data having a predetermined length (block length), it is impossible to encrypt longer data than the block length without modification. However, there have been developed an operation method (mode of operation) for encryption of long data using a block cipher algorithm, an operation method for creating an authentication code for detecting tampering of original data even when the data to be encrypted have a length longer than the block length, and the like. A cryptographic operation method used in a variety of applications based on the block cipher method as describe above is referred to as cryptography application mode.

By way of example of the mode of operation, the Xor-Encrypt-Xor (XEX)-based Tweaked CodeBook (TCB) mode with CipherText Stealing (CTS) (XTS) has been developed in order to particularly encryption stored in the storage apparatus. Specification thereof is defined in Institute of Electrical and Electronics Engineers (IEEE) P1619 (refer to SP800-38E/IEEE-Std-1619-2007).

In the XTS mode, encryption and decryption are performed using two kinds of key data including key data #1 used to encrypt input data and key data #2 used to creating a data initial mask value. In the cryptographic operation of the XTS mode, the initial mask value is initially created using a value called a tweak value and the key data #2. As the tweak value, typically, a sector number of the storage apparatus is used.

### BRIEF DESCRIPTION OF THE DRAWINGS

FIG. 1 is a diagram illustrating a functional configuration example of a cryptographic circuit according to one embodiment;

FIG. 2 is a diagram illustrating a functional configuration example of a storage apparatus according to the embodiment;

FIG. 3 is a flowchart illustrating an example of a cryptographic operation sequence of the XTS;

FIG. 4 is a diagram illustrating a functional configuration example of a data operation cryptographic module;

FIG. 5 is a flowchart illustrating an example of a write/read sequence of a storage apparatus according to the embodiment; and

FIG. 6 is a diagram illustrating an example of a concept of processing timings according to the embodiment.

### DETAILED DESCRIPTION

According to one embodiment, there is provided a cryptographic operation apparatus that performs a cryptographic operation for each first data unit using first key data for encrypting data and second key data for creating an initial mask value. The cryptographic operation apparatus includes an initial mask value creating unit that creates an initial mask value based on the second key data and data information determined for each second data unit larger than the first data unit. In addition, the cryptographic operation apparatus includes a mask value updating unit that generates a mask value for each of the first data unit based on the initial mask value and a mask value storing unit that stores the initial mask value and the mask value created by the mask value updating unit and outputs the stored mask value. Furthermore, the cryptographic operation apparatus includes a data cryptographic operation unit that creates encryption data by encrypting input data of the first data unit based on input data of the first data unit, the first key data, and the mask value output from the mask value storing unit in addition to the initial mask value creating unit.

Exemplary embodiments of a cryptographic operation apparatus, storage apparatus, and a cryptographic operation method will be explained below in detail with reference to the accompanying drawings. The present invention is not limited to the following embodiments.

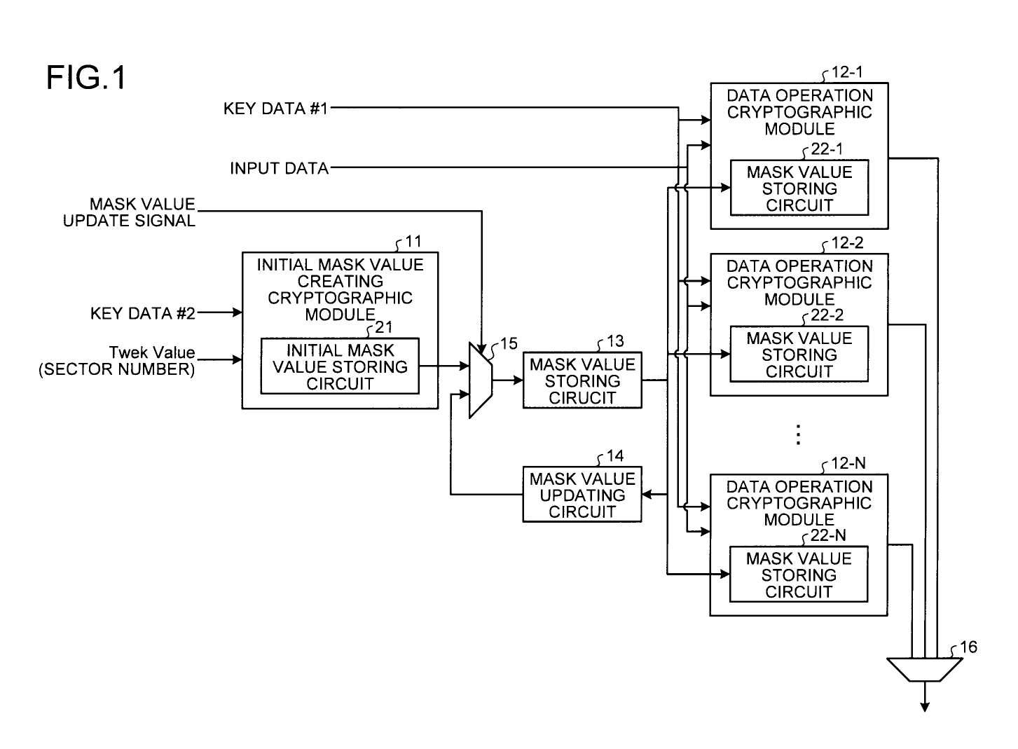

FIG. 1 is a diagram illustrating a functional configuration example of a cryptographic operation circuit (cryptographic operation apparatus) according to one embodiment. As shown in FIG. 1, the cryptographic circuit according to the embodiment includes an initial mask value creating cryptographic module (initial mask value creating unit) 11, a data operation cryptographic module (data cryptographic operation unit) 12-1 to 12-N, a mask value storing circuit (mask value storing unit) 13, a mask value updating circuit (mask value updating unit) 14, and selectors 15 and 16. In addition, the initial mask value creating cryptographic module (initial mask value creating operation unit) 11 has an initial mask value storing circuit 21, and the data operation cryptographic module (data cryptographic operation unit) 12-k (k=1, 2, . . . , N) has a mask value storing circuit (operational mask value storing unit) 22-k.

The cryptographic operation circuit 1 according to the embodiment is a circuit integrated into a non-volatile memory unit for storing data. The storage apparatus into which the cryptographic operation circuit 1 is integrated according to the embodiment may be, for example, a NAND type semiconductor memory device or a magnetic disk device, and a storage type is not particularly limited.

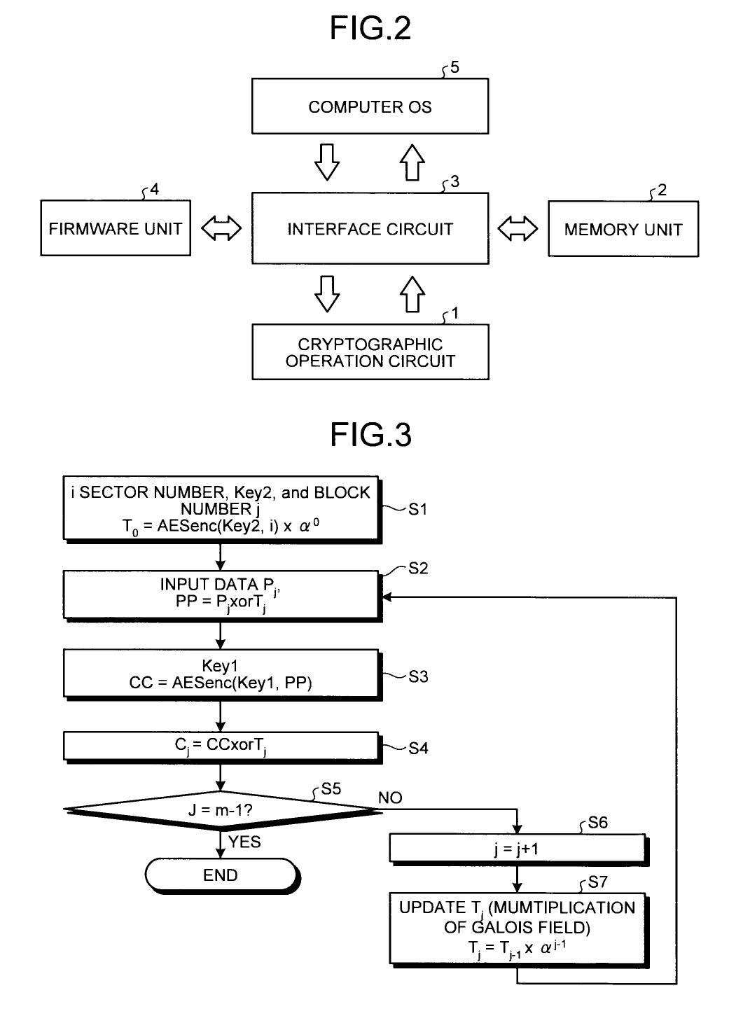

FIG. 2 is a diagram illustrating a functional configuration example of a storage apparatus according to the embodiment. As shown in FIG. 2, the storage apparatus according to the embodiment includes a memory unit 2, a cryptographic operation circuit 1 according to the embodiment, an interface circuit 3, and a firmware unit 4, and, for example, encrypts and stores the write target data input from a computer Operating System (OS) 5.

The storage apparatus according to the embodiment encrypts the input write target data and stores the data in the memory unit 2. Then, when the data stored in the memory unit 2 are read, the read data are decrypted and output. The memory unit 2 is a non-volatile memory unit for storing data such as a NAND flash memory.

The interface circuit 3 writes the data input from the computer OS 5 to the memory unit 2 based on the data write request from the computer OS 5 and reads the data stored in the memory unit 2 based on the data read request from the computer OS 5. In addition, the interface circuit 3 instructs the cryptographic operation circuit 1 to encrypt the write target data when data are written to the memory unit and to decrypt the read data when data are read from the memory unit 2. That is, the interface circuit 3 serves as a control unit for controlling the read/write operation and encryption/decryption of the data.

According to the embodiment, encryption data are created by writing the data into the memory unit 2 in the unit of block and encrypting the input data for each block. While the size of a single block is not particularly limited, herein, a single block consists of, for example, 128 bits. In addition, by configuring a single sector with a plurality of blocks, herein, a single sector consists of for example, 512 bytes. While the data amount of a single sector may be set to any value other than 512 bytes, herein, it is assumed that a single sector consists of a integer multiple of a single block.

Next, the operations according to the embodiment will be described. In the present embodiment, an XTS mode encryption method (hereinafter, referred to as the XTS) is used as a data encryption method for writing data into the memory unit 2. Here, the sector number is used as a tweak value used to create the initial mask value. Key information including a pair of key data #1 for creating the initial mask value and key data #2 for data encryption is used in the cryptographic operation of the XTS. This key information may be defined in any unit. It is assumed that the memory unit 2 is divided into a plurality of areas, and identical key information is used in each divided area. For example, when a capacity of 128 GB is used, identical key information is used for each 32 GB. Therefore, the sectors corresponding to the same area use the same key information. The interface circuit 3 stores a relationship between the key information and the areas and a relationship between the areas and the sector numbers within the areas, so that key information used for each sector number can be recognized.

Here, a typical encryption process of the XTS will be described. FIG. 3 is a flowchart illustrating an example of an encryption sequence of the XTS. FIG. 3 illustrates a case where the encryption process is performed for a single sector (for a sector number i (i denotes an integer number equal to or larger than zero). In order to continuously perform the encryption process for a plurality of sectors, the process shown in FIG. 3 is repeated by updating the sector number.

First, a process of creating an initial mask value T₀ is performed for the sector number i and the key data#2 (Key 2) based on the following equation (1) to initialize j to zero (step S1). In addition, a function AESenc( ) represents an AES encryption process as a sort of the block cipher operation process, and the α^{j} (j=0, 1, 2, m−1) represents a primitive element of Galois field, where m denotes the number of blocks in a single sector.

T₀=AESenc(Key2,i)×α⁰ (1)

Next, as the data encryption is initiated, first, exclusive OR PP is computed between input data (encryption target data) Pⱼ and Tⱼ corresponding to the (j)th block (step S2). Then, CC is computed for the PP and the key data #1 (Key 1) based on the following equation (2) (step S3), and further, exclusive OR is computed for CC and Tⱼ to obtain encryption data Cⱼ (step S4).

CC=AESenc(Key1,PP) (2)

Next, it is determined whether or not j=m−1 (that is, whether or not the last block of the sector is reached) (step S5). If it is determined that j=m−1 (YES in step S5), the encryption process of that sector is terminated. If it is determined that j≠m−1 (NO in step S5), j is incremented by one (step S6), Tⱼ is updated according to the following equation (3) (step S7), and the process returns to step S2.

Tⱼ=Tⱼ₋₁×α^{j-1} (3)

In this manner, in the encryption of the XTS, as described in conjunction with step S1, the initial mask value is created by carrying out the encryption. In addition, an operation for encrypting the input data (the write data) described in steps S2 to S4 is carried out using the initial mask value resulting from the encryption. The same encryption AESenc( ) is used in steps S1 and S3 while its input values are different. Therefore, when the operation is made using a single cryptographic module, the process shown in FIG. 3 is performed sequentially. For this reason, it is impossible to perform the encryption process for input data until creation of the initial mask value is terminated. In addition, in a case where data corresponding to a plurality of sectors are continuously written, if the encryption of the data corresponding to the sector that is being currently encrypted is not terminated even when necessary information is provided to create the initial mask value corresponding to the next sector, it is impossible to initiate a process of creating the initial mask value of the next sector.

In contrast, according to the present embodiment, in addition to the encryption modules (data operation cryptographic modules 12-1 to 12-N) for performing the encryption (corresponding to step S2) for the input data, an initial mask value creating cryptographic module is provided. Therefore, the a process of creating the initial mask value is initiated as soon as information necessary to create the initial mask value is prepared, and the processing result is stored in the initial mask value storing circuit 21. Since the stored initial mask value may be referenced when the encryption of the input data of the next sector is initiated, it is possible to reduce a standby time for creating the initial mask value.

Furthermore, according to the present embodiment, a plurality of cryptographic modules (data operation cryptographic modules 12-1 to 12-N) are provided to perform the encryption (corresponding to step S2) for the input data so that the encryption (steps S2 to S4) is carried out in parallel for each block. For this reason, it is possible to reduce a processing time of the encryption for the input data in comparison with a case where a single cryptographic module is used. In this case, while the initial mask value T₀ is used if j=0 in step S2 described above, the mask value Tⱼ updated in step S7 is used if j≧1, where j denotes a processing target block number.

In the operation for creating this mask value Tⱼ, if T₀ is created, mask values can be sequentially created in the order of T₁, T₀, . . . , and Tₘ₋₁ without waiting for the process of steps S2 to S4. According to the present embodiment, the mask value updating circuit 14 updates the mask value Tⱼ, and the updated mask value is stored in the mask value storing circuit 13 via the selector 15. In addition, the mask value Tⱼ stored in the mask value storing circuit 13 is stored in the mask value storing circuit 22-j of the data operation cryptographic module 12-j (here, by way of example, a data operation cryptographic module that performs the encryption of the (j)th block) that carries out the encryption of the (j)th block based on the instruction from the interface circuit 3.

In addition, if the mask value Tⱼ is stored in the mask value storing circuit 22-j, the interface circuit 3 instructs the mask value updating circuit 14 to update the mask value (creation of Tⱼ₊₁). In addition, the mask value Tⱼ₊₁ stored in the mask value storing circuit 13 is stored in the mask value storing circuit 22-(j+1) of the data operation cryptographic module 12-(j+1) that executes the encryption of the (j+1)th block based on the instruction of the interface circuit 3. Then, the mask values are sequentially updated and stored in the corresponding mask value storing circuits 22-1 to 22-N of the data operation cryptographic modules 12-1 to 12-N. Furthermore, if the interface circuit 3 receives the input data and the key data #1 and is instructed of activation, the data operation cryptographic module 12-j carries out the encryption of steps S2 to S4 using the mask value Tⱼ stored in the mask value storing circuit 22-j.

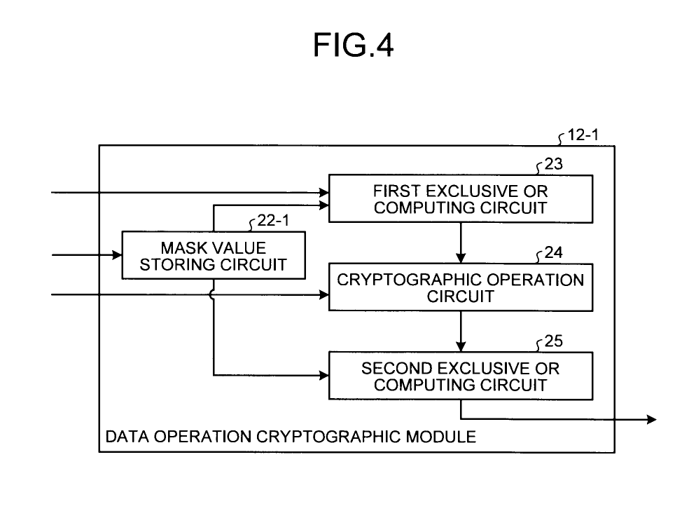

As described above, the data operation cryptographic modules 12-1 to 12-N according to the present embodiment carries out the encryption of steps S3 to S4. FIG. 4 is a diagram illustrating a configuration example of the data operation cryptographic module 12-1. The data operation cryptographic module 12-1 according to the present embodiment includes, for example, a mask value storing circuit 22-1 that stores the mask value Tⱼ, a first exclusive OR circuit 23 that computes exclusive OR PP between the mask value Tⱼ and the input data Pⱼ, a cryptographic operation circuit 24 that carries out the encryption of the XTS (block cipher operation) based on the PP and the key data #1 to obtain CC, and a second exclusive OR circuit 25 that computes exclusive OR between the CC and the mask value Tⱼ to obtain encryption data Cⱼ. The data operation cryptographic modules 12-2 to 12-N have the same configuration as that of the data operation cryptographic module 12-1. The data operation cryptographic modules 12-1 to 12-N may have any configuration if it can carry out the same operation.

A relationship between the data operation cryptographic module 12-1 and the processing target block may be established such that, for example, the process may advance sequentially from the initial block of the sector for the data operation cryptographic module 12-1, the data operation cryptographic module 12-2, and so on. Alternatively, the interface circuit 3 may select the cryptographic module for processing each block among unoccupied data operation cryptographic modules 12-1 to 12-N whenever the processing is made.

In addition, the initial mask value creating cryptographic module 11 can allow for a high speed decryption process. Hereinafter, the decryption will be described. According to the XTS, the same process as the initial mask value creating process of the encryption is carried out for the decryption process. That is, the same cryptographic operation as that of step S1 is also carried out for the decryption to obtain T₀. In addition, in the operation of decrypting the encryption data Cⱼ as input data, exclusive OR CC between Cⱼ and Tⱼ is computed in step S2′. Furthermore, in step S3′, the operation described in the following equation (4) is performed:

PP=AESdec(Key1,CC) (4)

where, the function AESdec( ) denotes an AES decryption. Next, in step S4′, exclusive OR P between PP and Tⱼ is obtained. Then, a decryption process is carried out for each block by performing the same process as steps S5 to S7 of the encryption process.

As described above, since the process of step S1 (decryption key creating process) is also carried out in the decryption process, the initial mask value creating cryptographic module 11 can carry out the process of step S1 in the decryption process. In addition, in the steps S2′ to S4′ of the process of decrypting the encryption data, the operation of the step S3′ is changed from encryption to decryption, and the other operations are the same except for their input. Therefore, the data operation cryptographic modules 12-1 to 12-N may carry out the decryption as well as the encryption. In addition, the initial mask value creating cryptographic module 11 may be shared by both the encryption and the decryption, and a plurality of data operation cryptographic modules for carrying out the decryption in parallel may be provided in addition to the data operation cryptographic modules 12-1 to 12-N.

In a case where the data operation cryptographic module 12-j according to the present embodiment also carries out the decryption, for example, the cryptographic operation circuit 24 described above is set to have a function of performing the decryption, the first exclusive OR circuit 23 described above computes exclusive OR CC between Cⱼ and Tⱼ, the cryptographic operation circuit 24 computes the decryption using CC and key data #1 (Key1) to obtain PP, and the second exclusive OR circuit 25 obtains exclusive OR P between PP and Tⱼ. A decryption unit may be further provided in addition to the encryption unit so that the decryption may be performed using CC and key data #1.

Similar to the encryption process, in a case where a plurality of sectors are sequentially processed in the decryption process, it is possible to perform the operation of step S1 as soon as information necessary for the process of step S1 is provided by allowing the initial mask value creating cryptographic module 11 different from the data operation cryptographic module to carry out the process of step S1 of the decryption process. Therefore, it is possible to reduce time elapsing for initiating the decryption of input data (encryption data in the case of the decryption).

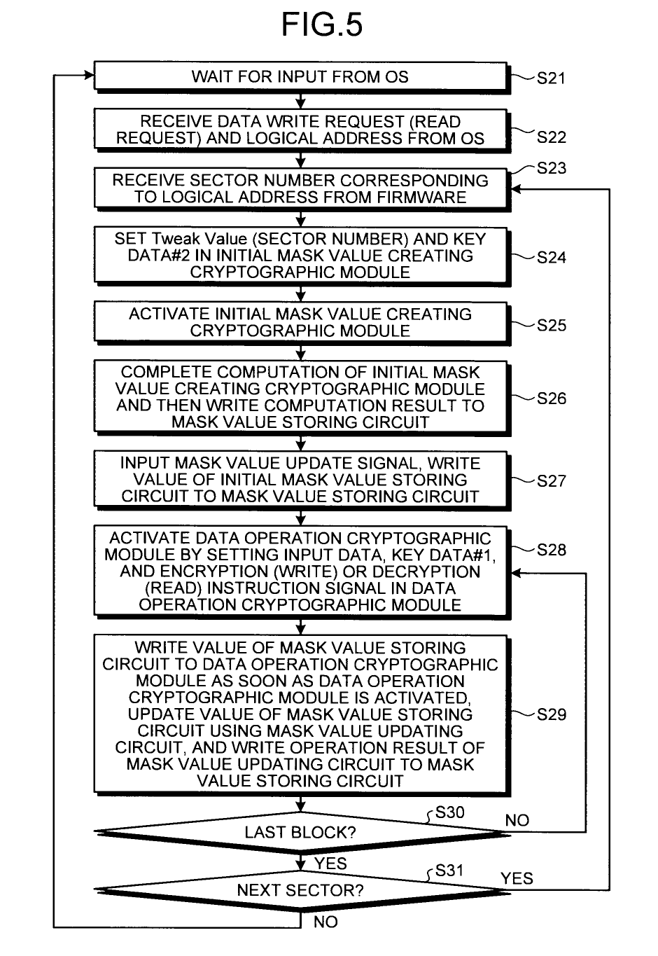

FIG. 5 is a flowchart illustrating an exemplary write and read sequence of the storage apparatus according to the embodiment. First, a write sequence will be described. The interface circuit 3 according to the embodiment waits for input from the computer OS 5 (step S21). When the interface circuit 3 receives a data write request (step S22), instructs the firmware unit 4 to obtain the sector number corresponding to a logical address requested by the write request, and receives the sector number corresponding to the logical address from the firmware unit 4 (step S23).

In addition, the computer OS 5 notifies the storage apparatus of the data write request (or a read request) and inputs the write target (read target) data to the storage apparatus (interface circuit 3). In addition, a logical address of the write target data may be instructed from the computer OS 5 or determined by the interface circuit 3. In addition, the firmware unit 4 stores a relationship between the logical address and the sector number, and outputs the sector number corresponding to the logical address based on the instruction from the interface circuit 3.

Next, the interface circuit 3 establishes the obtained sector number (tweak value) and key data #2 corresponding to the obtained sector number in the initial mask value creating cryptographic module 11 (step S24), and activates the initial mask value creating cryptographic module 11 (step S25).

The initial mask value creating cryptographic module 11 writes the operation result (initial mask value) to the initial mask value storing circuit 21 after completing the operation (step S26). The interface circuit 3 writes the initial mask value written to the initial mask value storing circuit 21 to the mask value storing circuit 13 in response to a mask value update signal (step S27). Specifically, the interface circuit 3 inputs the mask value update signal to the selector 15, and as a result, the selector 15 outputs the initial mask value written to the initial mask value storing circuit 21 to the mask value storing circuit 13 so as to store the value that has been input to the mask value storing circuit 13.

Next, the interface circuit 3 inputs the input data (the write target data), the key data #1, and the encrypting instruction signal to the operation cryptographic module 12-j corresponding to the block number of the input data to activate the corresponding module (step S28). Here, it is assumed that the data operation cryptographic modules 12-1 to 12-N are also used in the decryption, so that the operation cryptographic modules 12-1 to 12-N performs the encryption when the encryption instruction signal is input and performs the decryption when the decryption instruction signal is input.

In addition, the interface circuit 3 writes the mask value Tⱼ stored in the mask value storing circuit 13 to the mask value storing circuit 22-j of the data operation cryptographic module 12-j and instructs the mask value updating circuit 14 to update the mask value as soon as the data operation cryptographic module 12-j is activated. The interface circuit 3 also instructs the selector 15 to store the mask value Tⱼ₊₁ subjected to the update in the mask value storing circuit 13 (step S29).

The interface circuit 3 determines whether or not the input data of step S28 correspond to the last block of the sector (step S30). If it is determined that the input data do not correspond to the last block (NO in step S30), the interface circuit 3 increments the block number j by one and carries out the process for the next block by returning the process to step S28.

If it is determined that the input data of step S28 correspond to the last block of the sector (YES in step S30), then the interface circuit 3 determines whether or not the write process of the next sector is performed (whether or not the write process is continuously performed) (step S31). If it is determined that the write process of the next sector is performed (YES in step S31), the process returns to step S23, and the write process of the next sector is carried out. If it is determined that the write process of the next sector is not performed (NO in step S31), the process returns to step S21.

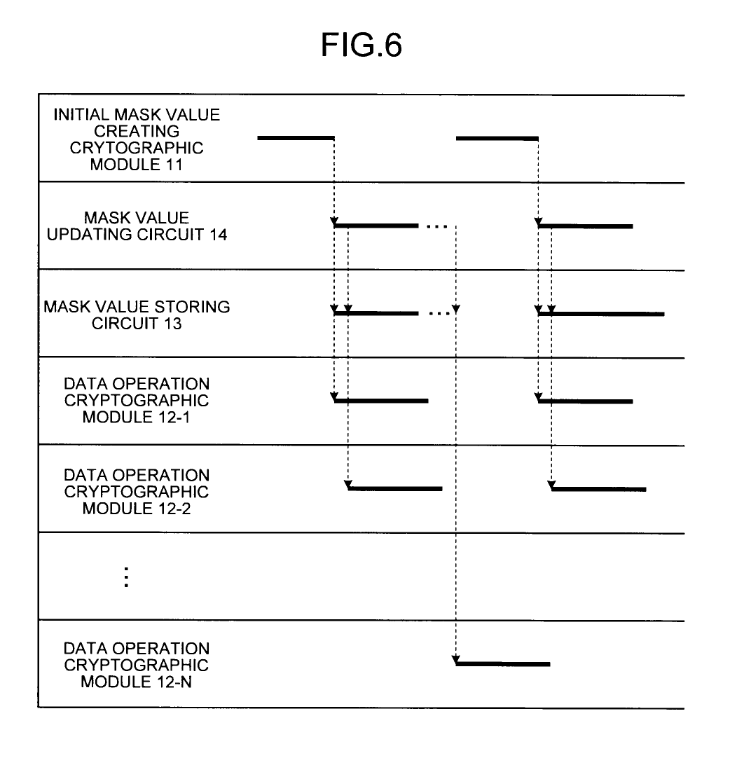

FIG. 6 is a diagram illustrating an exemplary processing timing concept according to the embodiment. In FIG. 6, the horizontal lines presented in each element denote a processing time. This exemplary processing timing represents an example of continuously performing the write operation, that is, the encryption, for a plurality of sectors. In addition, FIG. 6 illustrates an example in which the data operation cryptographic modules 12-1 to 12-N perform the process in the order of numbering such that the data operation cryptographic module 12-1 performs the encrypting process for the initial block of each sector, the data operation cryptographic module 12-2 performs the encrypting process for the next block, . . . , and so on.

As shown in FIG. 6, while the initial mask value creating cryptographic module 11 creates the initial value mask value for each sector, the mask value for the next sector may be computed even when the encryption of the data for the previous sector has not been completed. Since the computation of the initial mask value has been already completed when the input data for next sector are input to the data operation cryptographic module 12-1, it is possible to initiate the cryptographic operation as soon as the input data are provided. Furthermore, since the data operation cryptographic modules 12-1 to 12-N perform parallel processing, it is possible to perform a high-speed cryptographic operation. FIG. 6 is intended to illustrate concept of the processing timing, and an actual relationship between each processing time is different from that shown in FIG. 6. In addition, although the processing timing is exemplarily illustrated in FIG. 6, each of the processing timing is not limited thereto. Any processing timing can be employed if it can perform the parallel processing between the initial mask value creating cryptographic module 11 and the data operation cryptographic modules 12-1 to 12-N and the parallel processing between the data operation cryptographic modules 12-1 to 12-N.

While a write process case has been described hereinbefore, the process shown in FIG. 5 may be similarly carried out for a process of reading the encryption data from the memory unit 2. In the case of the read process, a read request is received in step S22 instead of the write request. In addition, in step S28, a decryption instruction signal is input to the data operation cryptographic module 12-j. In addition, in step S28, encryption data to be decrypted are read from the memory unit 2 and established as the input data.

The interface circuit 3 instructs the selector 16 one of the data operation cryptographic modules 21-1 to 12-N selected as the output data. The selector 16 selects any one of the output data from the data operation cryptographic modules 21-1 to 12-N based on the instruction. In the case of the data write process, the interface circuit 3 writes the data output from the selector 16 to the memory unit 2. In the case of the data read process, the interface circuit 3 outputs the data output from the selector 16 to the computer OS 5.

In this manner, according to the present embodiment, the initial mask value creating cryptographic module 11 is provided in addition to the cryptographic module for the data encryption, and a plurality of cryptographic modules for the data encryption (data operation cryptographic modules 12-1 to 12-N) are provided, so that the data encryption is processed for each block in parallel. For this reason, it is possible to achieve a high-speed data encryption, and at the same, create the initial mask value and the decryption key at an arbitrary timing regardless of the processing status of the data encryption. As a result, it is possible to further conceal the initial mask value creating process and the decryption key creating process. In addition, by configuring the circuit such that the mask value is stored in each of the data operation cryptographic modules 12-1 to 12-N, it is possible to update the initial mask value at an arbitrary timing without influencing the data operation that is being processed. Therefore, it is possible to achieve a cryptographic circuit capable of performing the encryption/decryption by mixing data of other sectors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cryptographic operation apparatus that performs a cryptographic operation for each first data unit using first key data for encrypting data and second key data for creating an initial mask value, the cryptographic operation apparatus comprising:
an initial mask value creating unit that creates an initial mask value based on the second key data and data information determined for each second data unit larger than the first data unit;
a mask value updating unit that generates a mask value for each of the first data unit based on the initial mask value;
a mask value storing unit that stores the initial mask value and the mask value created by the mask value updating unit and outputs the stored mask value; and
a data cryptographic operation unit that creates encryption data by encrypting input data of the first data unit based on input data of the first data unit, the first key data, and the mask value output from the mask value storing unit.

2. The cryptographic operation apparatus according to claim 1, wherein a plurality of the data cryptographic operation units are provided, and the mask value storing unit outputs the mask value corresponding to the input data to be processed by the data cryptographic operation unit for each of the data cryptographic operation unit.

3. The cryptographic operation apparatus according to claim 1, wherein the mask value updating unit creates the mask value by performing multiplication of a Galois field.

4. The cryptographic operation apparatus according to claim 1, wherein the data cryptographic operation unit includes
an operational mask value storing unit that stores the mask value input from the mask value storing unit,
a first exclusive OR computation unit that computes exclusive OR between the mask value stored in the operational mask value storing unit and the input data as a first operation result,
a cryptographic operation unit that computes a second operation result by carrying out a predetermined block cipher operation based on the first operation result and the first key data, and
a second exclusive OR computation unit that computes exclusive OR between the second operation result and the mask value stored in the operational mask value storing unit as the encryption data.

5. The cryptographic operation apparatus according to claim 1, wherein the encryption data are written to a memory device for storing data in a nonvolatile fashion, and
wherein the second data unit is a sector of the memory device, the first data unit is a block of the memory device, and the data information is a sector number.

6. The cryptographic operation apparatus according to claim 1, wherein the data cryptographic operation unit receives input of an instruction signal for instructing an encryption or a decryption, creates the encryption data obtained by encrypting the input data in a case where the instruction signal is a signal for instructing the encryption, and decrypts the input data in a case where the instruction signal is a signal for instructing the decryption.

7. The cryptographic operation apparatus according to claim 1, wherein the encryption is an encryption of XTS mode.

8. A storage apparatus comprising:
a memory unit including a plurality of non-volatile memory cells, each of the plurality of non-volatile memory cells being capable of storing data;
a cryptographic operation apparatus that performs an encryption for each first data unit using first key data for data encryption and second key data for creating an initial mask value; and
a control unit performs control such that the second key data and data information determined for each second data unit larger than the first data unit are input to the initial mask value creating unit, the first key data and input data of the first unit to be encrypted are input to the cryptographic operation apparatus, and the encryption data created by the cryptographic operation apparatus are written to the memory unit,
wherein the cryptographic apparatus unit includes
an initial mask value creating unit that creates an initial mask value based on the data information and the second key data input from the control unit,
a mask value updating unit that creates a mask value for each second data unit which is data unit of input data for performing an cryptographic operation based on the initial mask value,
a mask value storing unit that stores the initial mask value and the mask value created by the mask value updating unit and outputs the stored mask value, and
a data cryptographic operation unit that creates encryption data obtained by encrypting the input data of the first data unit based on the first key data, the input data of the first data unit input from the control unit, and the mask value output from the mask value storing unit.

9. The storage apparatus according to claim 8, wherein the data cryptographic operation unit receives input of an instruction signal for instructing an encryption or a decryption, creates the encryption data obtained by encrypting the input data when the instruction signal is a signal for instructing the encryption, and carries out the decryption for decrypting the input data when the instruction signal is a signal for instructing the decryption, and
wherein, in a case where a process of writing data to the memory unit is performed, the control unit performs control such that the instruction signal for instructing the encryption is input to the cryptographic operation unit, the second key data and the data information are input to the initial mask value creating unit, the first key data and input data of the second unit to be encrypted are input to the cryptographic operation apparatus, the encryption data created by the cryptographic operation apparatus are written to the memory unit, and the instruction signal for instructing the decryption is input to the cryptographic operation unit, and
wherein, in a case where a process of reading data from the memory unit is performed, the control unit performs control such that the encryption data are read, the second key data and the data information are input to the initial mask value creating unit, the first key data and the read encryption data are input to the cryptographic operation apparatus, and the decryption result of the cryptographic operation apparatus is output.

10. A cryptographic operation method in a cryptographic operation apparatus for performing a cryptographic operation for each first data unit using first key data for data encryption and second key data for creating an initial mask value,
the cryptographic operation apparatus includes an initial mask creating unit that creates an initial mask value, a mask value storing unit that stores a mask value, a mask value updating unit that updates the mask value, and a data cryptographic operation unit that performs a data cryptographic operation, the cryptographic operation method comprising:
creating by the initial mask creating unit the initial mask value based on the second key data and data information determined for each second data unit larger than the first data unit,
creating by the mask value updating unit the mask value for each of the first data unit based on the initial mask value,
storing by the mask value storing unit the initial mask value and the mask value created for each of the first data unit and outputs the stored mask value to the data cryptographic operation unit, and
creating by the data cryptographic operation unit encryption data obtained by encrypting input data of the first data unit based on input data of the first data unit, the first key data, and the mask value output to the data cryptographic operation unit.

11. The cryptographic operation method according to claim 10, wherein the cryptographic operation apparatus includes a plurality of the data cryptographic operation units, and
the mask value storing unit outputs a mask value corresponding to the input data to be processed by the data cryptographic operation unit to each of the data cryptographic operation units.

12. The cryptographic operation method according to claim 10, wherein the mask value updating unit creates the mask value by performing multiplication of a Galois field.

13. The cryptographic operation method according to claim 10, wherein the data cryptographic operation unit includes an operational mask value storing unit that stores the mask value input from the mask value storing unit, and
the data cryptographic operation unit computes exclusive OR between the input data and the mask value stored in the operational mask value storing unit to obtain a first operation result, computes a second operation result by carrying out a predetermined block cipher operation based on the first operation result and the first key data, and computes exclusive OR between the second operation result and the mask value stored in the operational mask value storing unit to obtain the encryption data.

14. The cryptographic operation method according to claim 10, wherein the encryption data are written to a non-volatile memory unit for storing data, and
the second data unit is a sector of the memory apparatus, the first data unit is a block of the memory apparatus, and the data information is a sector number.

15. The cryptographic operation method according to claim 10, wherein the data cryptographic operation unit receives input of an instruction signal for instruction an encryption or a decryption, and
wherein, in a case where the instruction signal is a signal for instructing the encryption, the encryption data are created by encrypting the input data, and in a case where the instruction signal is a signal for instructing the decryption, the decryption for decrypting the input data is carried out.
